(19) United States
(12) Patent Application Publication
(10) Pub. No.: US 2012/0057588 A1
(43) Pub. Date: Mar. 8, 2012

(54) MULTIPLE ANTENNA MULTIPLEXERS, DEMULTIPLEXERS AND ANTENNA ASSEMBLIES

(75) Inventors: Ayman Duzdar, Grand Blanc, MI (US); Joseph Michael Combi, Grand Blanc, MI (US); Gary Keith Reed, Grand Blanc, MI (US)

(73) Assignee: LAIRD TECHNOLOGIES, INC., Chesterfield, MO (US)

(21) Appl. No.: 13/280,327

(22) Filed: Oct. 24, 2011

Related U.S. Application Data
(63) Continuation-in-part of application No. 12/397,679, filed on Mar. 4, 2009, now Pat. No. 8,045,592.

(51) Int. Cl. H04H 20/67

(52) U.S. Cl. 370/339

(57) ABSTRACT

Exemplary embodiments of apparatus and methods relating to antenna multiplexers and demultiplexers are disclosed. In exemplary embodiments, antenna multiplexers include two or more inputs for receiving a corresponding number of signals from multiple antennas. The antennas may include a cellular antenna (e.g., world cell antennas or cellular antenna operable within one or more of AMPS/GSM850, GSM900, GSM1800, PCS/GSM1900, UMTS/AWS, GSM850, GSM1900, AWS, LTE, AMPS, PCS, EBS, BRS, WCS, etc.). The antennas may also include AM/FM antennas, SDARS antennas, GPS antennas, and/or antennas combining the preceding. Exemplary antenna multiplexers also include an output for simultaneously outputting the combined signals received by the multiplexer. Demultiplexers for receiving such combined signals and outputting each signal via a separate output are also disclosed.

### CROSS REFERENCE TO RELATED APPLICATION

This patent application is a continuation-in-part of and claims the benefit of U.S. patent application Ser. No. 12/397,679 filed Mar. 4, 2009 (issuing as U.S. Pat. No. 8,045,592 on Oct. 25, 2011). The disclosure of the application identified in this paragraph is incorporated herein by reference in its entirety.

### FIELD

The present disclosure relates to systems (e.g., multiplexers, etc.) or systems operable for receiving signals from multiple antennas and combining the received signals for transmission on a single output, and to systems (e.g., demultiplexers, etc.) operable for receiving multiple signals on a single input and outputting the signals on separate outputs.

### BACKGROUND

This section provides background information related to the present disclosure which is not necessarily prior art.

There are numerous, varied wireless communication standards in existence today, many of which operate within different frequency bands. Examples include Wi-Fi, Global Positioning System (GPS), Broadband Personal Communications Service (PCS)/Global System for Mobile Communications 1900 (GSM1900), Universal Mobile Telecommunications System (UMTS)/Advanced Wireless Service (AWS), Amplified Modulated Phone Service (AMPS)/Global System for Mobile Communications 850 (GSM850), Amplitude Modulation (AM)/Frequency Modulation (FM) radio, Long Term Evolution (LTE), etc.

Often, a separate antenna is used to receive each type of signal. Some antennas are operable to receive signals from two or more frequency bands. Each antenna typically is attached to a separate cable, such as a coaxial cable, for coupling a signal received by the antenna to the location at which the signal will be used, such as a radio receiver, GPS navigation device, cellular phone, etc.

### SUMMARY

This section provides a general summary of the disclosure, and is not a comprehensive disclosure of its full scope or all of its features.

Exemplary embodiments of apparatus and methods relating to antenna multiplexers and demultiplexers are disclosed. In exemplary embodiments, antenna multiplexers include two or more inputs for receiving a corresponding number of signals from multiple antennas. The antennas may include a cellular antenna (e.g., world cell antennas or cellular antenna operable within one or more of AMPS/GSM850, GSM900, GSM1800, PCS/GSM1900, UMTS/AWS, GSM850, GSM1900, AWS, LTE, AMPS, PCS, EBS, BRS, WCS, etc.). The antennas may also include AM/FM antennas, SDARS antennas, GPS antennas, and/or antennas combining the preceding. Exemplary antenna multiplexers also include an output for simultaneously outputting the combined signals received by the multiplexer. Demultiplexers for receiving such combined signals and outputting each signal via a separate output are also disclosed.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure in any way.

FIG. 1 is a block diagram of an exemplary embodiment of an antenna system including a GPS antenna, a world cell antenna, and a multiplexer for combining signals from the antennas in the system according to aspects of the present disclosure.

FIG. 2 is a graph of S21 and S22 simulation results for the world cell portion of the multiplexer in FIG. 1.

FIG. 3 is a graph of S21 and S22 simulation results for the GPS portion of the multiplexer in FIG. 1.

FIG. 4 is a graph of overall S11 simulation results for the multiplexer in FIG. 1.

FIG. 5 is a block diagram of an exemplary embodiment of an antenna system including a GPS and SDARS antenna, a world cell antenna, and a multiplexer for combining signals from the antennas in the system according to aspects of the present disclosure.

FIG. 6 is block diagram of an exemplary embodiment of an antenna system including an SDARS antenna, an AM/FM antenna, and a multiplexer for combining signals from the antennas in the system according to aspects of the present disclosure.

FIG. 7 is a block diagram of an exemplary embodiment of an antenna system including a SDARS/GPS antenna, a world cell/AM/FM antenna, and a multiplexer for combining signals from the antennas in the system according to aspects of the present disclosure.

FIG. 8 is a block diagram of an exemplary embodiment of an exemplary embodiment of an antenna system including a SDARS antenna, a GPS antenna, a world cell/AM/FM antenna, and a multiplexer for combining signals from the antennas in the system according to aspects of the present disclosure.

FIG. 9 is a block diagram of an exemplary embodiment of a demultiplexer for demultiplexing combined world cell/AM/FM/satellite signals output by a multiplexer according to aspects of the present disclosure.

FIG. 10 is a block diagram of an exemplary embodiment of a demultiplexer for demultiplexing combined AM/FM/satellite signals output by a multiplexer according to aspects of the present disclosure.

FIG. 11 is a block diagram of an exemplary embodiment of a demultiplexer for demultiplexing combined world cell/satellite signals output by a multiplexer according to aspects of the present disclosure.

Corresponding reference numerals indicate corresponding parts throughout the several views of the drawings.

### DETAILED DESCRIPTION

In the following description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication and manufacture for those of ordinary skill.

According to various aspects of the present disclosure, systems, apparatus, or assemblies (which may also be referred to as antenna combiners or multiplexers, etc.) for combining signals from a plurality of antennas are disclosed. As disclosed herein, a multiplexer may be operable to combine multiple input signals received by the multiplexer and output the combined signals on a single output. Thus, multiple antennas for receiving various signals (e.g., signals having different frequencies, types, etc.) can be connected to a multiplexer disclosed herein such that a single communication line or link (e.g., a coaxial cable, other communication line, etc.) may be used to carry the multiple signals simultaneously from the multiplexer to a location at which it is desired that the multiple signals be received. The location for receiving the signals may be, for example, the location of an AM/FM radio receiver, a cellular telephone phone or smart phone, a global positioning satellite (GPS) receiver, a satellite digital audio radio service (SDARS) receiver, a receiver comprising some or all of the preceding, etc.

At least some systems, apparatus, assemblies, or multiplexers according to the present disclosure may be used in connection with an automobile. Some automobile manufacturers have begun integrating various combinations of radio, GPS, SDARS, cellular devices (e.g., cellular phones, smartphones, etc.), etc. into their vehicles. Each of the various antennas used for such services are typically connected to a different cable, or wire, which is routed to a receiver located around a dashboard of the vehicle. By employing at least some aspects of the present disclosure, the number of cables from the antennas to the console may be reduced. A multiplexer according to the present disclosure may be installed in a vehicle at a location near the various antennas. A plurality of the antennas may be connected to the multiplexer, and a single communication line or link (e.g., coaxial cable, other suitable communication line, etc.) may be routed from the multiplexer output to the console of the vehicle to carry the signals received from the plurality of antennas connected to the multiplexer.

In an exemplary embodiment, an antenna multiplexer includes a first input configured for receiving a communication signal from a cellular antenna (e.g., world cell antenna or cellular antenna operable within one or more (or all) of AMPS/GSM850, GSM900, GSM1800, PCS/GSM1900, UMTS/AWS, GSM850, GSM1900, AWS, LTE, AMPS, PCS, EBS, BRS, WCS, etc.). In operation, the antenna multiplexer may receive communication signals that fall within one or more frequency bandwidths associated with cellular communications, such as one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 below, etc.

Continuing with this example, the multiplexer further includes a second input configured for receiving a satellite signal from a satellite antenna. The multiplexer also includes an output for outputting a combined signal including the communication signal and the satellite signal.

Another exemplary embodiment includes an antenna multiplexer including a first input for receiving a radio signal from an AM/FM antenna. The multiplexer also includes a second input for receiving a satellite digital audio radio service (SDARS) signal from a SDARS antenna and an output for simultaneously outputting signals received by the antenna multiplexer.

Other exemplary embodiments include an antenna multiplexer having a first input for receiving a radio signal from an AM/FM antenna and a second input for receiving a communication signal from a cellular antenna (e.g., world cell antenna or cellular antenna operable within one or more (or all) of AMPS/GSM850, GSM900, GSM1800, PCS/GSM1900, UMTS/AWS, GSM850, GSM1900, AWS, LTE, AMPS, PCS, EBS, BRS, WCS, etc.).

The multiplexer includes a third input for receiving a satellite signal from a satellite antenna and an output for simultaneously outputting signals received by the antenna multiplexer. In operation, the antenna multiplexer may receive communication signals that fall within one or more frequency bandwidths associated with cellular communications, such as one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 below, etc.

In yet another exemplary embodiment, an antenna demultiplexer includes an input capable of simultaneously receiving radio signal from an AM/FM antenna, a satellite signal from a satellite antenna, and a communication signal from a cellular antenna (e.g., world cell antenna or cellular antenna operable within one or more (or all) of AMPS/GSM850, GSM900, GSM1800, PCS/GSM1900, UMTS/AWS, GSM850, GSM1900, AWS, LTE, AMPS, PCS, EBS, BRS, WCS, etc.). The demultiplexer further includes a first output for outputting the radio signal, a second output for outputting the communication signal, and a third output for outputting the satellite signal. In operation, the demultiplexer may receive communication that fall within one or more frequency bandwidths associated with cellular communications, such as one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 below, etc.

According to still another example embodiment, an antenna demultiplexer includes an input capable of simultaneously receiving radio signal from an AM/FM antenna, and a satellite digital audio radio service (SDARS) signal from a SDARS antenna. The demultiplexer includes a first output for outputting the radio signal, and a second output for outputting the SDARS signal.

In another example embodiment, an antenna demultiplexer includes an input capable of simultaneously receiving a satellite signal from a satellite antenna and a communication signal from a cellular antenna (e.g., a world cell antenna or cellular antenna operable within one or more (or all) of AMPS/GSM850, GSM900, GSM1800, PCS/GSM1900, UMTS/AWS, GSM850, GSM1900, AWS, LTE, AMPS, PCS, EBS, BRS, WCS, etc.). The demultiplexer includes a first output for outputting the communication signal and a second output for outputting the satellite signal. In operation, the demultiplexer may receive communication that fall within one or more frequency bandwidths associated with cellular communications, such as one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 below, etc.

In another example embodiment of an antenna system, multiplexer, or combiner, a first input is configured for receiving a communication signal from a cellular antenna (e.g., a world cell antenna or cellular antenna operable within one or more (or all) of AMPS/GSM850, GSM900, GSM1800, PCS/GSM1900, UMTS/AWS, GSM850, GSM1900, AWS, LTE, AMPS, PCS, EBS, BRS, WCS, etc.). In such embodiments, the antenna multiplexer may be used in various geographical locations or regions throughout the world where these cellular frequency bandwidths are used. As disclosed herein, such exemplary embodiments may enable a one cable solution for a worldwide telematics program in that the combination allows for a common interface to be used in any of the various geographical locations or regions throughout the world where these frequency bandwidths are used. This, in turn, may thus provide a universal or common design style usable in these various locations. Such exemplary embodiments may also allow for reduced costs by reducing the number of cables and number of vehicle cable harnesses.

Exemplary embodiments may be used with or include an antenna configured to be operable or cover frequencies or frequency bands, such as LTE (700 MHz), Cellular (AMPS), AWS, PCS, EBS (Educational Broadband Services), BRS (Broadband Radio Services), WCS (Broadband Wireless Communication Services/Internet Services, etc. Additionally, or alternatively, exemplary embodiments may be used with or include an antenna configured to be operable with one or more of the frequencies or frequency bands listed immediately below in Table 1 and/or Table 2.

TABLE 1

| | Upper Frequency | Lower Frequency |
|---|---|---|
| System/Band Description | (MHz) | (MHz) |
| 700 MHz Band | 698 | 862 |
| B17 (LTE) | 704 | 787 |
| AMPS/GSM850 | 824 | 894 |
| GSM 900 (E-GSM) | 880 | 960 |
| DCS 1800/GSM1800 | 1710 | 1880 |
| PCS/GSM1900 | 1850 | 1990 |
| W CD MA/UMTS | 1920 | 2170 |
| 2.3 GHz Band IMT Extension | 2300 | 2400 |
| IEEE 802.11B/G | 2400 | 2500 |
| EBS/BRS | 2496 | 2690 |
| W IMAX MMDS | 2500 | 2690 |
| BROADBAND RADIO | 2700 | 2900 |
| SERVICES/BRS (MMDS) | | |
| W IMAX (3.5 GHz) | 3400 | 3600 |
| PUBLIC SAFETY RADIO | 4940 | 4990 |

TABLE 2

| | |
|---|---|
| Tx/Uplink | Rx/Downlink |
| (MHz) | (MHz) |

| Band | Start | Stop | Start | Stop |
|---|---|---|---|---|
| GSM 850/AMPS | 824.00 | 849.00 | 869.00 | 894.00 |
| GSM 900 | 876.00 | 914.80 | 915.40 | 959.80 |
| AWS | 1710.00 | 1755.80 | 2120.00 | 2180.00 |
| GSM 1800 | 1710.20 | 1784.80 | 1805.20 | 1879.80 |
| GSM 1900 | 1850.00 | 1910.00 | 1930.00 | 1990.00 |
| UMTS | 1920.00 | 1980.00 | 2110.00 | 2170.00 |
| LTE | 2010.00 | 2025.00 | 2010.00 | 2025.00 |
| LTE | 2300.00 | 2400.00 | 2300.00 | 2400.00 |
| LTE | 2496.00 | 2690.00 | 2496.00 | 2690.00 |
| LTE | 2545.00 | 2575.00 | 2545.00 | 2575.00 |
| LTE | 2570.00 | 2620.00 | 2570.00 | 2620.00 |

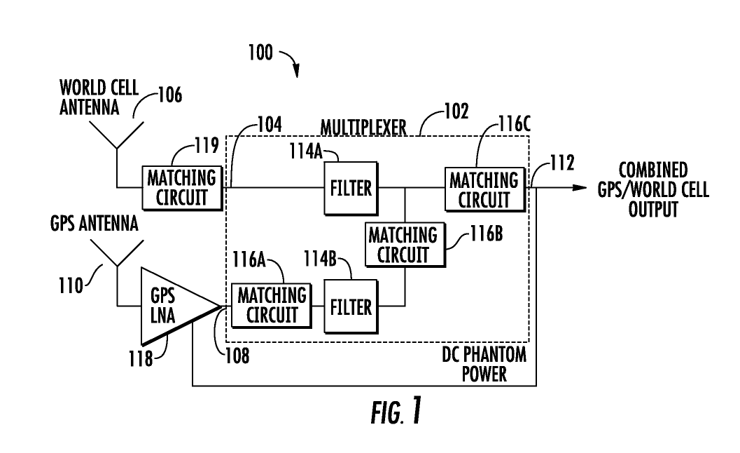

Turning now to FIG. 1, there is shown an example embodiment of an antenna system 100 including an antenna multiplexer 102 according to at least one aspect of the present disclosure. The multiplexer 102 includes a first input 104 for receiving a communication signal from a world cell antenna 106. In various embodiments, a communication signal may also be transmitted from the multiplexer 102 to the word cell antenna 106 via the input 104, in which case the input 104 may also be referred to as an input/output. Other embodiments may include an output separate from, and not combined with, the input 104.

The world cell antenna 106, in this and some other exemplary embodiments of this disclosure, is operable to receive AMPS/GSM850, GSM900, GSM1800, PCS/GSM1900, and UMTS/AWS communication signals. The frequencies of such signals typically fall within the 824-960 MHz bandwidth and the 1710-2170 MHz bandwidth. Some exemplary embodiments may include a world cell antenna that is additionally or alternatively operable for receiving signals associated with one or more other frequency bands, such as one or more (or all) of GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, etc.

With continued reference to FIG. 1, the multiplexer 102 further includes a second input 108 for receiving a satellite signal from a satellite antenna 110. The multiplexer 102 also includes an output 112 for outputting a combined signal that includes the communication signal and the satellite signal.

In various embodiments, a single communication link or line (e.g., a single coaxial cable, etc.) may be routed from the multiplexer output 112, for example, to a console of a vehicle to carry the combined communication/satellite signal. By way of example, the power (e.g., DC power, etc.) for operating the multiplexer 102 may be provided by a GPS receiver via the same coaxial cable that is routed from the multiplexer output 112 and carries the combined communication/satellite signal. This is generally referred to as “DC PHANTOM POWER” in FIG. 1. In such example, the GPS receiver knows that the GPS antenna 110 is in communication with the GPS receiver by sensing the current drawn by the GPS LNA 118. Alternatively, phantom power could be provided by other means besides the GPS receiver, such as the AM/FM radio receiver, the car's electrical system directly, etc. The power may also be used for operating amplifiers (e.g., a low noise amplifier (LNA), etc.) and/or antennas (e.g., antennas having amplifiers built in, etc.). In some embodiments, a voltage regulator may be used to provide a different voltage for components that need a different (typically lower) voltage than the (e.g., approximately 12 volts, etc.) phantom DC voltage.

According to at least one exemplary embodiment, the multiplexer 102 includes a plurality of filters 114A, 114B, sometimes collectively referred to herein as filters 114. In this example, the filters 114 allow certain frequency signals to pass through the filter, while preventing other frequencies from passing. Although each of the filters 114 is illustrated as a single block, the filters 114 may be a single filter or a plurality of filters. The filters 114 may be any suitable filter, such as a high pass filter, low pass filter, bandpass filter, notch filter, etc., or any combination thereof. In the example embodiment of FIG. 1, the filter 114A permits the communications signals from and to the world cell antenna 106 to pass the filter 114A, but prevents the satellite signals from the satellite antenna 110 from passing to the filter 114A. To the satellite signals, the filter 114A may appear as an open circuit. Thus, satellite signals are prevented from passing to the world cell antenna 106 and being radiated out and received by the satellite antenna 110 (which may create an unstable feedback loop). Conversely, the filter 114B permits the satellite signals from the satellite antenna 110 to pass the filter 114B, but prevents the communications signals from and to the world cell antenna 106 from passing the filter 114B. To the communications signals, the filter 1148 may appear as an open circuit. Thus, communication signals are prevented from passing to the satellite antenna 110 and being radiated out and received by the world cell antenna 106 (which may create an unstable feedback loop).

The multiplexer 102 may also include a plurality of matching circuits 116A, 116B, 116C (collectively matching circuits 116). The matching circuits 116 mitigate signal degradation. The matching circuits 116 are typically used to match impedances in order to reduce signal reflections, standing waves, etc. More particularly, the matching circuit 116A, for example, matches the impedance of the satellite antenna 110, which may include a low noise amplifier (LNA) 118, with the filter 114B. The matching circuit 116B compensates for impedance changes brought about by the filter 114B to reduce signal degradation when the output of filter 114B is combined with the output of filter 114A. Finally, matching circuit 116C may be used to alter the output impedance of the multiplexer 102. A fourth matching circuit 119 is part of, or coupled to, the world cell antenna 106 and is not illustrated as part of the multiplexer 102. But in some embodiments, particularly those for use with world cell antennas without an integrated matching circuit 119, the matching circuit 119 may be part of the multiplexer 102.

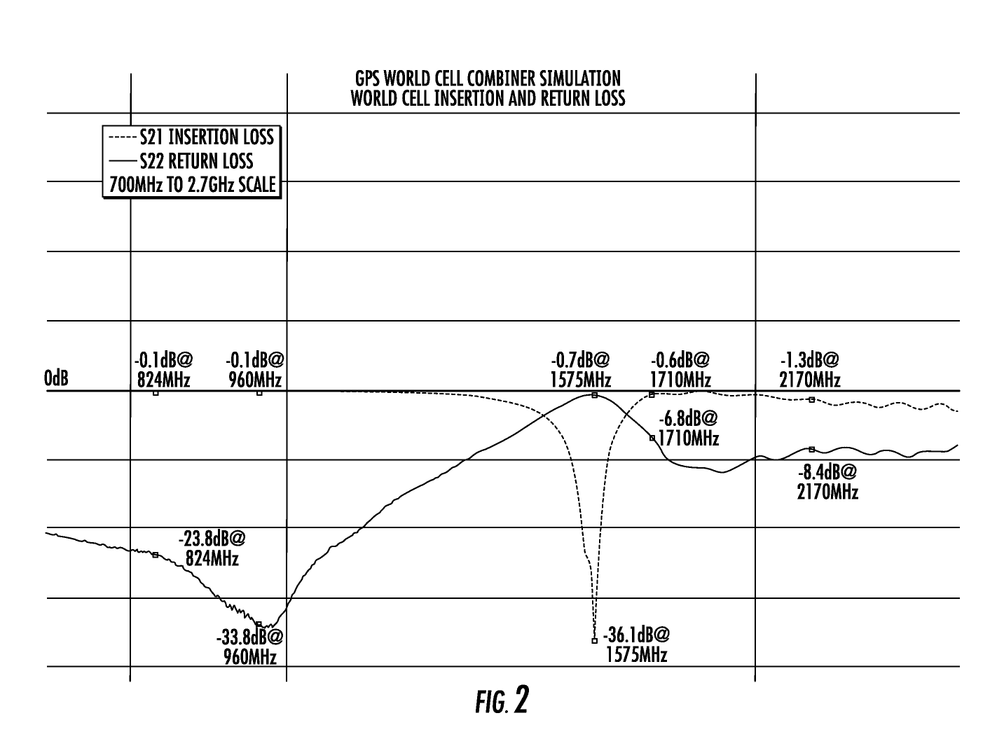

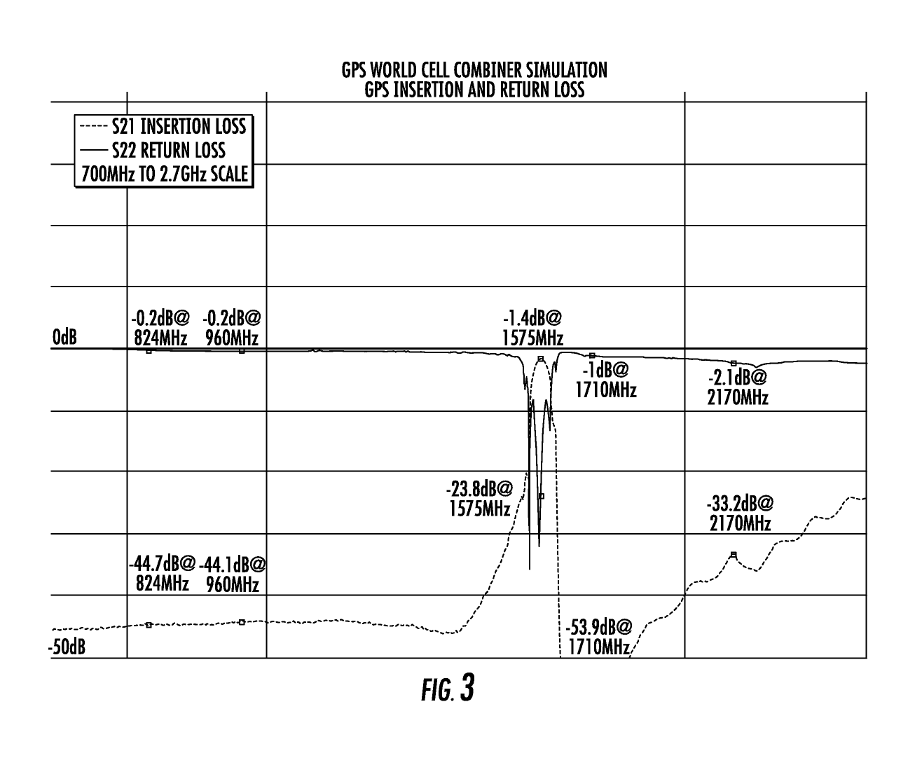

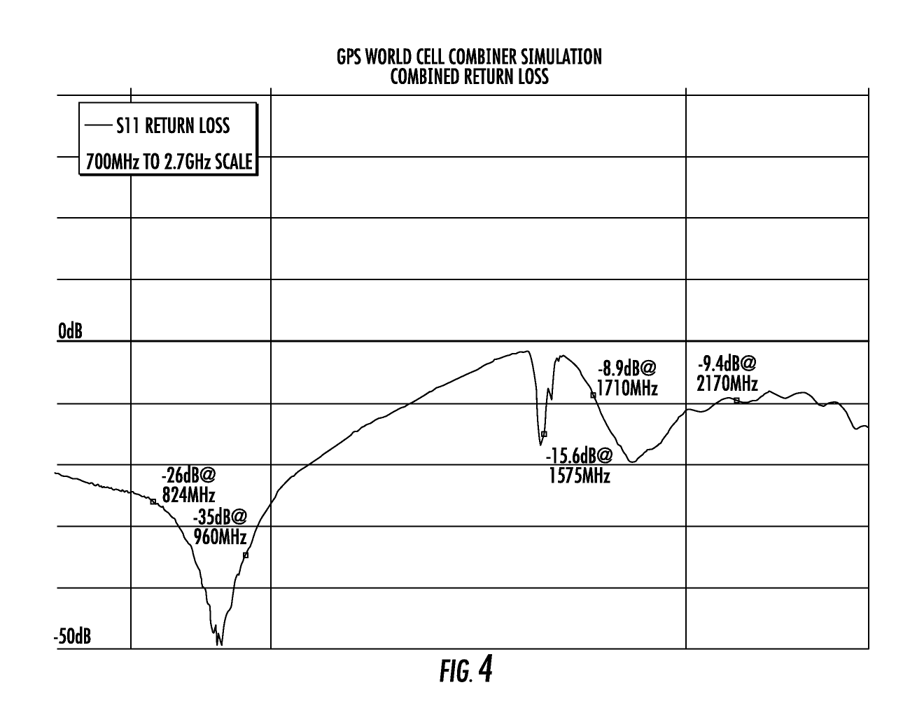

S21 insertion loss and S22 return loss simulation results for the multiplexer 102 of FIG. 1 are graphically illustrated in FIGS. 2 and 3. The simulation results for the world cell antenna 106 branch of the multiplexer 102 are illustrated in FIG. 2. As can be seen in FIG. 2, this branch of the multiplexer passes signals having a frequency of about 824-960 MHz and 1710-2170 MHz, while rejecting signals having a frequency around 1575 MHz. Thus, this branch will permit communications signals from the world cell antenna 106 to pass and block signals from the satellite antenna (which in this embodiment is a GPS antenna for receiving GPS signals of about 1575 MHZ). Conversely, as can be seen in FIG. 3, the satellite antenna 110 branch of the multiplexer passes signals having a frequency around 1575 MHz and blocks signals having a frequency of about 824-960 MHz and 1710-2170 MHz. The overall S11 return loss of the multiplexer 102 is graphed in FIG. 4.

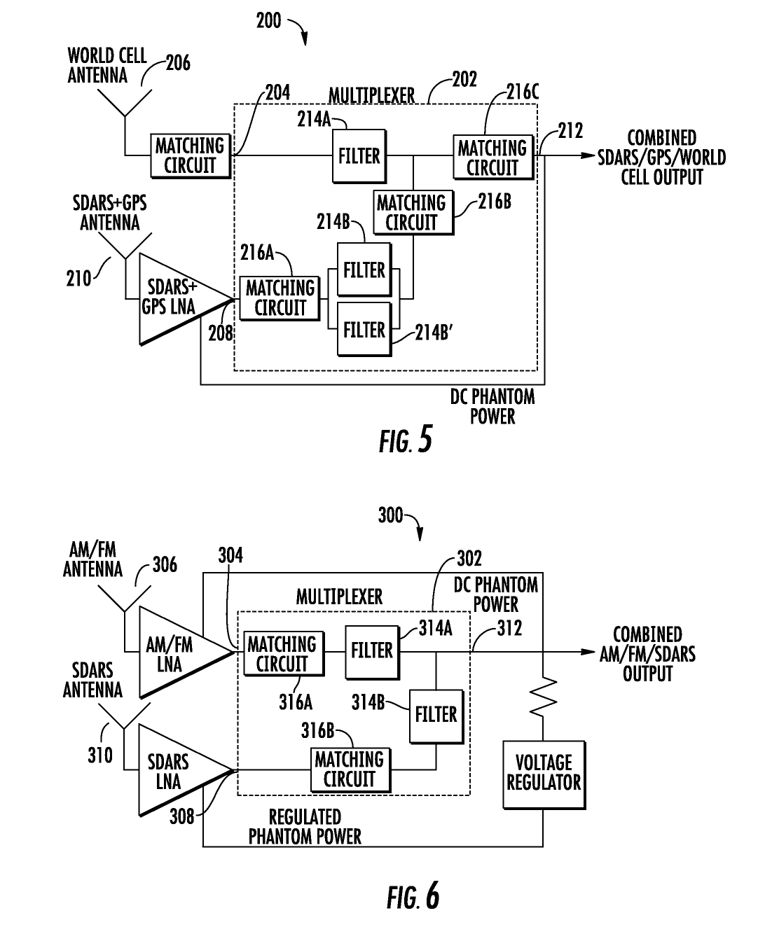

FIG. 5 illustrates another exemplary embodiment of an antenna system 200 that includes another multiplexer 202 according to at least one aspect of the present disclosure. As shown in FIG. 5, the multiplexer 202 includes a first input 204 for receiving a communication signal from a world cell antenna 206. The world cell antenna 206 may be configured to be operable to receive communication signals within one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 above, etc.

In various embodiments, a communication signal may also be transmitted from the multiplexer 202 to the word cell antenna 206 via the input 204, in which case the input 204 may also be referred to as an input/output. Other embodiments may include an output separate from, and not combined with, the input 204.

The multiplexer 202 further includes a second input 208 for receiving a satellite signal from a satellite antenna 210. The multiplexer 202 also includes an output 212 for outputting a combined signal including the communication signal and the satellite signal. The satellite antenna 210 is a combined GPS and satellite digital audio radio service (SDARS) antenna. In various embodiments, a single communication link or line (e.g., a single coaxial cable, etc.) may be routed from the multiplexer output 212, for example, to a console of a vehicle to carry the combined communication/GPS/SDARS signal. By way of example, the power (e.g., DC power, etc.) for operating the multiplexer 202 may be provided by a GPS receiver and/or SDARS receiver via the same coaxial cable that is routed from the multiplexer output 212 and carries the combined communication/GPS/SDARS signal. This is generally referred to as “DC PHANTOM POWER” in FIG. 5. In such example, the GPS and/or SDARS receiver knows that the antenna 210 is in communication with the GPS and/or SDARS receiver by sensing the current drawn by the SDARS+GPS LNA. Alternatively, phantom power could be provided by other means besides GPS receiver and SDARS receiver, such as the AM/FM radio receiver, the car's electrical system directly, etc. The power may also be used for operating amplifiers (e.g., LNAs, etc.) and/or antennas (e.g., antennas having amplifiers built in, etc.). In some embodiments, a voltage regulator may be used to provide a different voltage for components that need a different (typically lower) voltage than the (e.g., approximately 12 volts, etc.) phantom DC voltage.

The multiplexer 202 is similar to the multiplexer 102 in FIG. 1. and operates similarly. The multiplexer includes a plurality of matching circuits 216A, 216B, 216C and filters, 214A, 214B, 214B′. Filters 214B and 214B′ may be a single filter, a combination of filters, separate single filters, separate combinations of filters, etc. Because the satellite antenna 210 is a combined GPS and SDARS antenna, however, the satellite signals received at the second input 208, may including GPS signals and/or SDARS signals. Accordingly, filter 214B may be configured to permit GPS signals to pass, while blocking passage of other signals. Similarly, the filter 214B′ may be configured to permit SDARS signals (e.g., signals having a frequency about 2300 MHz) to pass, while limiting or preventing passage of signals having other frequencies.

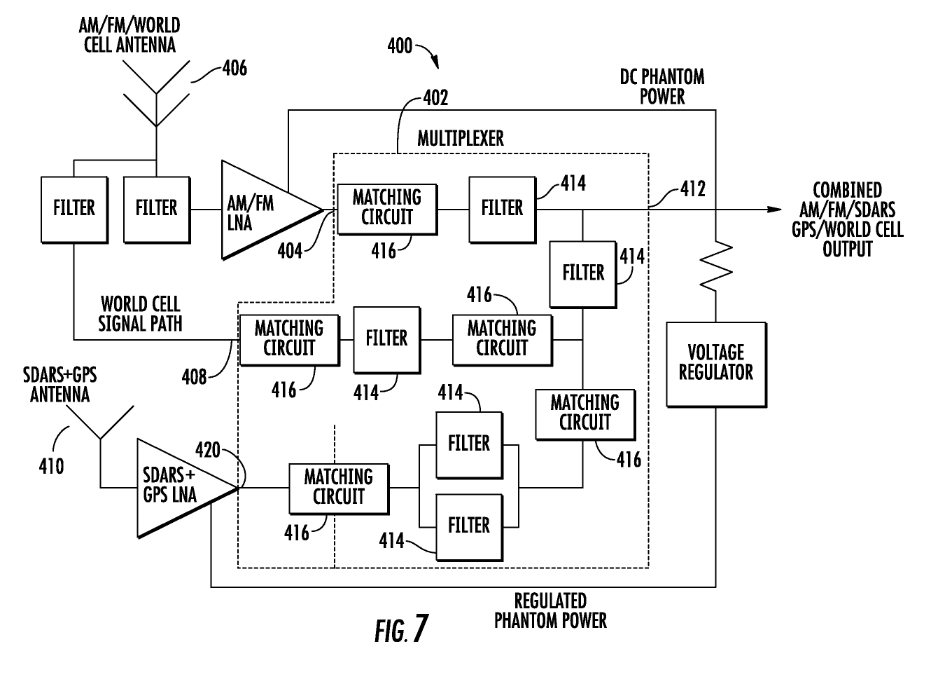

FIG. 6 illustrates another embodiment of an antenna system 300 that includes another example multiplexer 302 according to at least one aspect of the present disclosure. As shown in FIG. 6, the multiplexer 302 includes a first input 304 for receiving a radio signal from an AM/FM antenna 306. The multiplexer 302 includes a second input 308 for receiving a SDARS signal from a SDARS antenna 310.

The multiplexer 302 also includes an output 312 for simultaneously outputting signals received by the antenna multiplexer 302. In various embodiments, a single communication link or line (e.g., a single coaxial cable, etc.) may be routed from the multiplexer output 312, for example, to a console of a vehicle to carry the combined AM/FM/SDARS signal. By way of example, the power (e.g., DC power, etc.) for operating the multiplexer 302 may be provided by an AM/FM receiver (“DC PHANTOM POWER”) and/or SDARS receiver (“REGULATED PHANTOM POWER”) via the same coaxial cable that is routed from the multiplexer output 312 and carries the combined AM/FM/SDARS signal. In addition, a voltage regulator may also be provided as shown in FIG. 6 to provide a different voltage for components that need a different (typically lower) voltage than the (e.g., approximately 12 volts, etc.) phantom DC voltage. In this example, the AM/FM receiver knows that the AM/FM antenna 306 is in communication with the AM/FM receiver by sensing the current drawn by the AM/FM LNA. Similarly, the SDARS receiver knows that the SDARS antenna 310 is in communication with the SDARS receiver by sensing the current drawn by the SDARS LNA. Alternatively, phantom power could be provided by other means besides the AM/FM receiver and SDARS receiver, such as the car's electrical system directly, etc. The power may also be used for operating amplifiers (LNA) and/or antennas (e.g., antennas having amplifiers built in, etc.).

According to at least one exemplary embodiment, the multiplexer 302 includes a plurality of filters 314A, 314B, sometimes collectively referred to as filters 314. As with filters 114 and 214, each of the filters 314 allows certain frequency signals to pass through the filter 314, while preventing signals having other frequencies from passing. The filter 314A permits the radio signals from the AM/FM antenna 306 to pass the filter 314A, but prevents the SDARS signals from the SDARS antenna 310 from passing the filter 314A. To the SDARS signals, the filter 314A may appear as an open circuit. Thus, SDARS signals are prevented from passing to and radiating from the AM/FM antenna 306 and being received by the SDARS antenna 310 (which may create an unstable feedback loop). Conversely, the filter 314B permits the SDARS signals from the SDARS antenna 310 to pass the filter 314B, but prevents the radio signals from the AM/FM antenna 306 from passing the filter 314B. To the radio signals, the filter 314B may appear as an open circuit. Thus, radio signals are prevented from passing to and being radiated from the SDARS antenna 310 and being received by the AM/FM antenna 306 (which may create an unstable feedback loop).

The multiplexer 302 may also include a plurality of matching circuits 316A, 316B (collectively matching circuits 316). As with matching circuits discussed above, the matching circuits 316 mitigate signal degradation. The matching circuits 316 may be used to match impedances in order to reduce signal reflections, standing waves, etc.

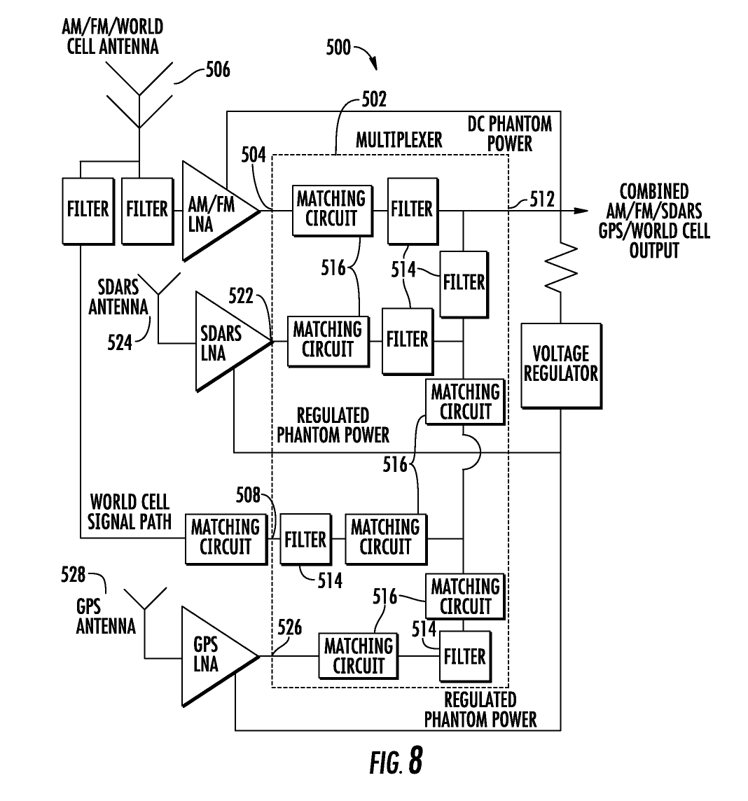

FIG. 7 illustrates yet another embodiment of an antenna system 400 that includes an antenna multiplexer 402 according to at least one aspect of the present disclosure. As shown in FIG. 7, the multiplexer 402 includes a first input 404 for receiving a radio signal from an AM/FM antenna, which is part of a combined world cell/AM/FM antenna 406. The multiplexer 402 also includes a second input 408 for receiving a communication signal from a world cell antenna 406, which is also part of the combined world cell/AM/FM antenna 406. In various embodiments, a communication signal may also be transmitted from the multiplexer 402 to the word cell antenna via the input 408, in which case the input 408 may also be referred to as an input/output. Other embodiments may include an output separate from, and not combined with, the input 408.

In this example embodiment, the world cell antenna and the AM/FM antenna are provided via the combined world cell/AM/FM antenna 406. But other embodiments may include an AM/FM antenna that is separate from (and not combined with) a world cell antenna. Continuing with a description of the exemplary world cell/AM/FM antenna 406, the world cell antenna of this embodiment is operable to receive AMPS/GSM850, GSM900, GSM1800, PCS/GSM1900, and UMTS/AWS communication signals. Additionally, or alternatively, the world cell antenna may be configured to be operable to receive communication signals within one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 above, etc.

The multiplexer 402 includes a third input 420 for receiving a satellite signal from a satellite antenna 410. The multiplexer 402 includes an output 412 for simultaneously outputting signals received by the antenna multiplexer 402. In various embodiments, a single communication link or line (e.g., a single coaxial cable, etc.) may be routed from the multiplexer output 412, for example, to a console of a vehicle to carry the combined AM/FM/communication/satellite signal. By way of example, the power (e.g., DC power, etc.) for operating the multiplexer 402 may be provided by an AM/FM receiver (“DC PHANTOM POWER”) and/or SDARS and/or GPS receiver (“REGULATED PHANTOM POWER”) via the same coaxial cable that is routed from the multiplexer output 412 and carries the combined AM/FM/communication/satellite signal. In addition, a voltage regulator may also be provided as shown in FIG. 7 to provide a different voltage for components that need a different (typically lower) voltage than the (e.g., approximately 12 volts, etc.) phantom DC voltage. In this example, the AM/FM receiver knows that the AM/FM antenna is in communication with the AM/FM receiver by sensing the current drawn by the AM/FM LNA. Similarly, the GPS and/or SDARS receiver knows that the antenna 410 is in communication with the GPS and/or SDARS receiver by sensing the current drawn by the SDARS+GPS LNA. Alternatively, phantom power could be provided by other means, such as the car's electrical system directly, etc. The power may also be used for operating amplifiers (LNA) and/or antennas (e.g., antennas having amplifiers built in, etc.).

The multiplexer 402 combines features of the multiplexers 202 (FIG. 5) and 302 (FIG. 6). According to at least one exemplary embodiment, the multiplexer 402 includes a plurality of filters 414. As with filters 114, 214, and 314, each of the filters 414 allows certain frequency signals to pass through the filter, while preventing signals having other frequencies from passing.

The multiplexer 402 may also include a plurality of matching circuits 416. As with matching circuits discussed above, the matching circuits 416 mitigate signal degradation. The matching circuits 416 may be used to match impedances in order to reduce signal reflections, standing waves, etc.

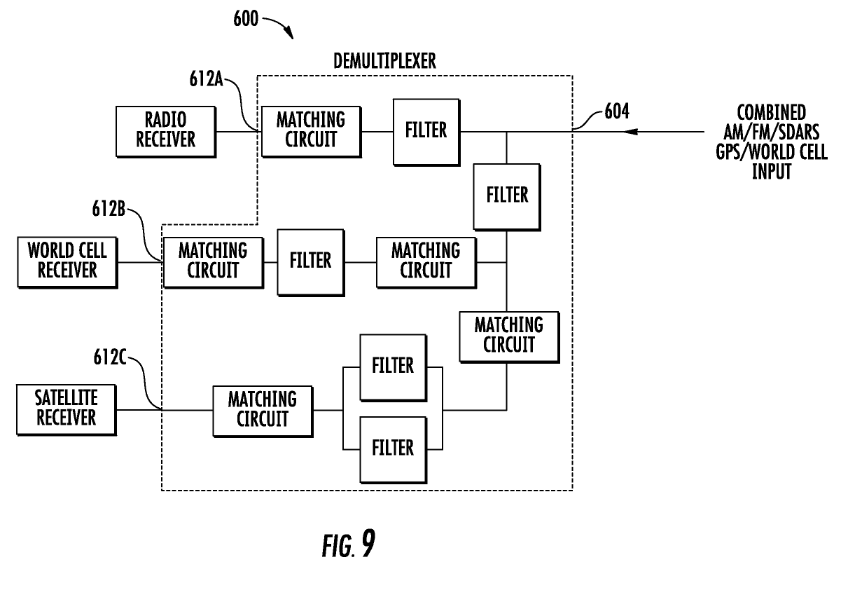

The antenna system 400 shown in FIG. 7 includes a combined SDARS and GPS satellite antenna 410. In the alternative embodiment shown in FIG. 8, the antenna system 500 includes separate SDARS and GPS antennas. A multiplexer 502 incorporates aspects of several, or all, of the multiplexers discussed above.

In the particular embodiment illustrated in FIG. 8, the multiplexer 502 includes a first input 504 for receiving a radio signal from an AM/FM antenna (which is part of the combined AM/FM/world cell antenna 506) and a second input 508 for receiving a communication signal from a world cell antenna (which is also part of the combined AM/FM/world cell antenna 506). In various embodiments, a communication signal may also be transmitted from the multiplexer 502 to the word cell antenna via the input 508, in which case the input 508 may also be referred to as an input/output. Other embodiments may include an output separate from, and not combined with, the input 508.

In this example embodiment, the world cell antenna and the AM/FM antenna are provided via the combined world cell/AM/FM antenna 506. But other embodiments may include an AM/FM antenna that is separate from (and not combined with) a world cell antenna. Continuing with a description of the exemplary world cell/AM/FM antenna 506, the world cell antenna of this embodiment is operable to receive AMPS/GSM850, GSM900, GSM1800, PCS/GSM1900, and UMTS/AWS communication signals. Additionally, or alternatively, the world cell antenna may be configured to be operable to receive communication signals within one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 above, etc.

The multiplexer 502 includes a third input 522 for receiving a SDARS signal from a SDARS antenna 524. The multiplexer 502 has a fourth input 526 for receiving a GPS signal from a GPS antenna 528.

The multiplexer 502 includes an output 512 for simultaneously outputting signals received by the antenna multiplexer 502. In various embodiments, a single communication link or line (e.g., a single coaxial cable, etc.) may be routed from the multiplexer output 512, for example, to a console of a vehicle to carry the combined AM/FM/communication/SDARS/GPS signal. By way of example, the power (e.g., DC power, etc.) for operating the multiplexer 502 may be provided by an AM/FM receiver (“DC PHANTOM POWER”) and/or GPS receiver (“REGULATED PHANTOM POWER”) via the same coaxial cable that is routed from the multiplexer output 412 and carries the combined AM/FM/communication/SDARS/GPS signal. In addition, a voltage regulator may also be provided as shown in FIG. 8 to provide a different voltage for components that need a different (typically lower) voltage than that (e.g., approximately 12 volts, etc.) phantom DC voltage. In this example, the AM/FM receiver knows that the AM/FM antenna is in communication with the AM/FM receiver by sensing the current drawn by the AM/FM LNA. Similarly, the SDARS receiver knows that the GPS antenna 528 is in communication with the GPS receiver by sensing the current drawn by the GPS LNA. Alternatively, phantom power could be provided by other means, such as the car's electrical system directly, etc. The power may also be used for operating amplifiers (e.g., LNA, etc.) and/or antennas (e.g., antennas having amplifiers built in, etc.).

According to at least one exemplary embodiment, the multiplexer 502 includes a plurality of filters 514. As with filters 114, 214, 314, and 414, each of the filters 514 allows certain frequency signals to pass through the filter 514, while preventing signals having other frequencies from passing.

The multiplexer 502 may also include a plurality of matching circuits 516. As with matching circuits discussed above, the matching circuits 516 mitigate signal degradation. The matching circuits 516 may be used to match impedances in order to reduce signal reflections, standing waves, etc.

Additionally, demultiplexing the combined signals (the signals output by the multiplexers discussed above) may be accomplished by reversing the operations discussed above with reference to the multiplexers. Thus, similar circuits, if not exactly identical, to the multiplexers above may receive the output of a multiplexer as an input and output several separate signals.

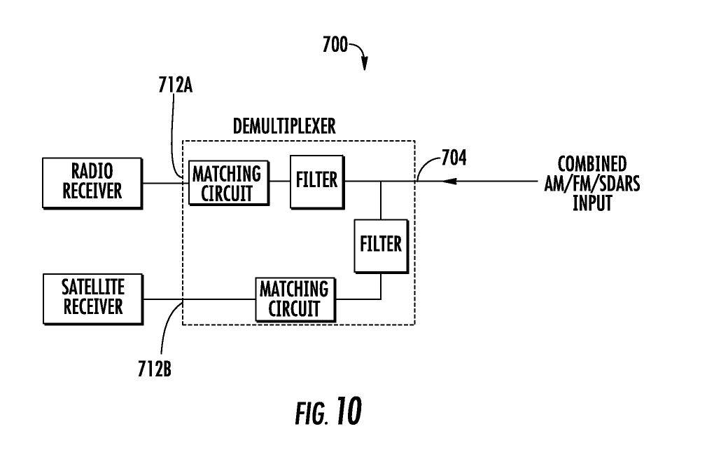

For example, FIG. 9 illustrates an antenna demultiplexer 600 embodying at least one aspect of the present disclosure. As shown, the demulitplexer 600 includes an input 604 capable of simultaneously receiving (e.g., from the multiplexer 400 (FIG. 7), from the multiplexer 500 (FIG. 8), etc.) a radio signal from an AM/FM antenna, a communication signal from a world cell antenna operable to receive AMPS/GSM850, GSM900, GSM1800, PCS/GSM1900, and UMTS/AWS communication signals, and a satellite signal (e.g., GPS signal and/or SDARS signal, etc.) from a satellite antenna (e.g., GPS antenna, SDARS antenna, combined GPS/SDARS antenna, etc.). In this example embodiment, the demultiplexer's input 604 is illustrated as receiving a combined AM/FM/SDARS/GPS/world cell signal. Additionally, or alternatively, the input 604 may be configured for receiving communication signals from a world cell antenna operable to receive communication signals within one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 above, etc.

The demultiplexer 600 may further include a first output 612A for outputting the radio signal, a second output 612B for outputting the communication signal, and a third output 612C for outputting the satellite signal. In various embodiments, the demultiplexer 600 may include a fourth output for outputting whichever satellite signal (the SDARS signal or GPS signal) is not already being output by the third output 612C.

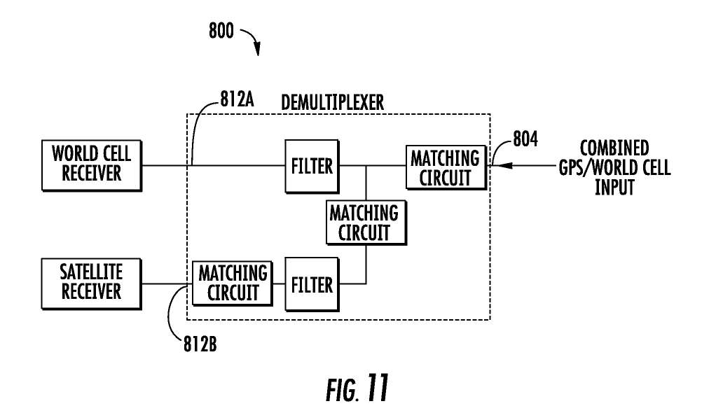

As still another example, FIG. 10 illustrates another antenna demultiplexer 700, which includes an input 704 capable of simultaneously receiving (e.g., from the multiplexer 300 (FIG. 6), etc.) a radio signal from an AM/FM antenna and a satellite digital audio radio service (SDARS) signal from a SDARS antenna. In this example embodiment, the demultiplexer's input 604 is illustrated as receiving a combined AM/FM/SDARS signal. The demultiplexer 700 may include a first output 712A for outputting the radio signal and a second output 712B for outputting the SDARS signal.

FIG. 11 illustrates another example embodiment of an antenna demultiplexer 800. The demultiplexer 800 includes an input 804 capable of simultaneously receiving (e.g., from the multiplexer 100 (FIG. 1), from the multiplexer 200 (FIG. 5), etc.) a communication signal from a world cell antenna operable to receive AMPS/GSM850, GSM900, GSM1800, PCS/GSM1900, and UMTS/AWS communication signals, and a satellite signal (e.g., GPS signal and/or SDARS signal, etc.) from a satellite antenna (e.g., GPS antenna, SDARS antenna, combined GPS/SDARS antenna, etc.). Additionally, or alternatively, the input 84 may be configured for receiving communication signals from a world cell antenna operable to receive communication signals within one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 above, etc.

In this example embodiment, the demultiplexer's input 804 is illustrated as receiving a combined GPS/world cell signal. The demultiplexer 800 may include a first output 812A for outputting the communication signal and a second output 812B for outputting the satellite signal.

Accordingly, exemplary embodiments of apparatus and methods relating to antenna multiplexers and demultiplexers are disclosed. In exemplary embodiments, antenna multiplexers include two or more inputs for receiving a corresponding number of signals from multiple antennas. The antennas may include a cellular antenna (e.g., world cell antennas or cellular antenna operable within one or more (or all) of AMPS/GSM850, GSM900, GSM1800, PCS/GSM1900, UMTS/AWS, GSM850, GSM1900, AWS, LTE, AMPS, PCS, EBS, BRS, WCS, etc.). The antennas may also include AM/FM antennas, SDARS antennas, GPS antennas, and/or antennas combining the preceding. Exemplary antenna multiplexers also include an output for simultaneously outputting the combined signals received by the multiplexer. Demultiplexers for receiving such combined signals and outputting each signal via a separate output are also disclosed.

Although the example embodiments in the foregoing detailed description may refer to GPS, other satellite based positioning systems may be included as an alternative to (or in addition to) GPS antennas and signals. For example, the multiplexers, demultiplexers, antennas, systems, etc. may be operable for other global navigation satellite systems such as the European Galileo system, the Russian GLONASS, the Chinese Beidou navigation system, the Indian IRNSS, etc. Also, cellular or world cell antennas referred to herein may additionally, or alternatively be configured for receiving communication signals from a world cell antenna operable to receive communication signals within one or more (or all) of AMPS/GSM850, GSM900, GSM1800, PCS/GSM1900, UMTS/AWS, GSM850, GSM1900, AWS, LTE (e.g., 4G, 3G, other LTE generation, B17 (LTE), LTE (700 MHz), etc.), AMPS, PCS, EBS, BRS, WCS, cellular frequency bandwidth(s) associated with or unique to a particular one or more geographic regions or countries, one or more frequency bandwidth(s) from Table 1 and/or Table 2 above, etc.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

Terms such as “first,” “second,” and other numerical terms when used herein do not imply a sequence or order unless clearly indicated by the context.

Disclosure of values and ranges of values for specific parameters (such as frequency ranges, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The foregoing description of the embodiments of the present invention has been provided for purposes of illustration and description. It is not intended to be exhaustive or to limit the invention to the precise forms disclosed. Individual elements or features of a particular embodiment are generally not limited to that particular embodiment, but, where applicable, are interchangeable and can be used in a selected embodiment, even if not specifically shown or described.

What is claimed is:

1. An antenna multiplexer comprising:
a first input configured to receive a communication signal from and transmit a communication signal to a cellular antenna;
a second input configured to receive a satellite signal from a satellite antenna;
a first filter coupled to the first input and configured to limit the satellite signal from passing to the cellular antenna;
a second filter coupled to the second input and configured to limit the received and transmitted communication signals from passing to the satellite antenna;
an output configured to output a combined signal including the communication signals and the satellite signal;
a first matching circuit configured to adjust an output impedance of the multiplexer;
a second matching circuit coupled between the second input and the second filter; and
a third matching circuit coupled between the first filter and the second filter;
whereby the antenna multiplexer is operable via DC phantom power provided to the antenna multiplexer through the output.

2. The antenna multiplexer of claim 1, wherein the first and second filters comprise first and second notch filters, and wherein the first input is configured to receive a communication signal from and transmit a communication signal to a cellular antenna operable for use with one or more AMPS/GSM850, GSM900, GSM1800, PCS/GSM1900, UMTS/AWS, and LTE communication signals.

3. The antenna multiplexer of claim 1, wherein the first input is configured to receive a communication signal from and transmit a communication signal to a cellular antenna operable for use with LTE communication signals.

4. The antenna multiplexer of claim 1, wherein the first input is configured to receive a communication signal from and transmit a communication signal to a cellular antenna operable for use with AMPS/GSM850, GSM900, GSM1800, PCS/GSM1900, UMTS/AWS, and LTE communication signals.

5. The antenna multiplexer of claim 1, wherein the first input is configured to receive a communication signal from and transmit a communication signal to a world cell antenna operable for use with at least a first and a second frequency bandwidth, and wherein the multiplexer does not separate communication signals in the first frequency bandwidth from communication signals in the second frequency bandwidth.

6. The antenna multiplexer of claim 1, wherein:
the satellite antenna is a combined satellite digital audio radio service (SDARS) and GPS antenna;
the satellite signal includes a GPS signal and an SDARS signal;
the antenna multiplexer further includes a third filter coupled between the second input and the third matching circuit to permit the SDARS signal to pass through the third filter and limit passage of other signals; and
the second filter is configured to permit the GPS signal to pass through the second filter and limit passage of other signals.

7. The antenna multiplexer of claim 1, further comprising a third input for receiving a radio signal from an AM/FM antenna.

8. The antenna multiplexer of claim 7, wherein:
the second input is operable for receiving a satellite signal comprising a GPS signal and an SDARS signal from a combined SDARS/GPS antenna; and
the output is operable for outputting a combined signal including the radio signal, the received and transmitted communication signal, the GPS signal, and the SDARS signal.

9. The antenna multiplexer of claim 7, wherein:
the second input is operable for receiving a satellite signal comprising a GPS signal and an SDARS signal from a combined SDARS/GPS antenna;
the antenna multiplexer includes:
a third filter coupled to the third input to permit the radio signal to pass through the third filter and limit passage of other signals;
the first filter is operable to permit the received and transmitted communication signals to pass through the first filter and limit passage of other signals;
the second filter is operable to permit the SDARS signal to pass through the second filter and limit passage of other signals; and
a fourth filter coupled to the second input to permit the GPS signal to pass through the fourth filter and limit passage of other signals.

10. An antenna system comprising:
the antenna multiplexer of claim 7;
an AM/FM antenna coupled to the third input to provide the radio signal;
a world cell antenna coupled to the first input to provide and transmit the communication signals; and
a satellite antenna coupled to the second input to provide the satellite signal.

11. The antenna multiplexer of claim 7, wherein the satellite antenna is a satellite digital audio radio services (SDARS) antenna and the satellite signal is an SDARS signal, the antenna multiplexer further comprising:
a fourth input for receiving a global positioning satellite (GPS) signal from a GPS antenna; and
a fourth filter coupled to the fourth input to permit the GPS signal to pass through the fourth filter and limit passage of other signals;
wherein the output is operable for outputting a combined signal including the received and/or transmitted communication signal, the SDARS signal, the radio signal, and the GPS signal.

12. The antenna multiplexer of claim 7, wherein the first and third inputs are operable for receiving the radio signal and for receiving and transmitting the communication signal, respectively, from a combined AM/FM/world cell antenna.

13. An antenna system comprising the antenna multiplexer of claim 1 and a single communication line routed from the multiplexer output for carrying the signals output by the multiplexer output.

14. The system of claim 13, wherein the single communication line is a single coaxial cable.

15. The system of claim 13, further comprising an antenna demultiplexer including an input for receiving signals carried by the single communication line routed from the multiplexer output.

16. The antenna multiplexer of claim 1, wherein the satellite antenna is a global positioning satellite (GPS) antenna or a combined satellite digital audio radio service (SDARS) and GPS antenna.

17. The antenna multiplexer of claim 1, wherein the second matching circuit is configured to match an impedance of the satellite antenna to a filter impedance of the second filter, and wherein the third matching circuit is configured to match a second filter output to a first filter output.

18. An antenna system comprising:
a first input configured to receive a communication signal from and transmit a communication signal to a cellular antenna operable for use with LTE communication signals;
a second input configured to receive a satellite signal from a satellite antenna;
a first notch filter coupled to the first input and configured to limit the satellite signal from passing to the cellular antenna;
a second notch filter coupled to the second input and configured to limit the received and transmitted communication signals from passing to the satellite antenna;
an output configured to output a combined signal including the communication signals and the satellite signal;
a first matching circuit configured to adjust an output impedance of the antenna system;
a second matching circuit coupled between the second input and the second notch filter and configured to match an impedance of the satellite antenna to a filter impedance of the second notch filter; and
a third matching circuit coupled between the first notch filter and the second notch filter and configured to match a second notch filter output to a first filter output.

19. The antenna system of claim 18, wherein the antenna system is operable via DC phantom power provided to the antenna system through the output.

20. An antenna system comprising:
a first input configured to receive a communication signal from and transmit a communication signal to a cellular antenna operable for use with operable for use with AMPS/GSM850, GSM900, GSM1800, PCS/GSM1900, UMTS/AWS, and LTE communication signals.
a second input configured to receive a satellite signal from a satellite antenna;
a first filter coupled to the first input and configured to limit the satellite signal from passing to the cellular antenna;
a second filter coupled to the second input and configured to limit the received and transmitted communication signals from passing to the satellite antenna;
an output configured to output a combined signal including the communication signals and the satellite signal;
a single communication line routed from the multiplexer output for carrying the signals output by the multiplexer output.
whereby the antenna system is operable via DC phantom power provided to the antenna system through the output.
